(19) United States
(12) Patent Application Publication
(10) Pub. No.: US 2018/0199305 A1
(43) Pub. Date: Jul. 12, 2018

(54) INDOOR POSITIONING METHOD, WIRELESS RECEIVING DEVICE, WIRELESS TRANSMISSION DEVICE AND STORAGE MEDIUM

(71) Applicant: ZTE Corporation, Shenzhen, Guangdong (CN)

(72) Inventors: Yang GAO, Shenzhen (CN); Jun LIU, Shenzhen (CN)

(21) Appl. No.: 15/527,383

(22) PCT Filed: May 21, 2015
(86) PCT No.: PCT/CN2015/079487

§ 371 Date: May 17, 2017

(30) Foreign Application Priority Data
Nov. 24, 2014 (CN) 201410680531.X

(51) Int. Cl. H04W 64/00; H04W 4/33

(52) U.S. Cl. CPC H04W 64/003; G01C 21/206; H04W 4/33

(57) ABSTRACT

Disclosed are an indoor positioning method, a wireless receiving device, a wireless transmission device and a storage medium. Position information transmitted by at least one opposite end is received through an air interface transmission interface. According to the position information of the at least one opposite end, position information of a local end is determined via a positioning algorithm.

### TECHNICAL FIELD

The disclosure relates to communications and in particular to an indoor positioning method, a wireless receiving device, a wireless transmission device and a storage medium.

### BACKGROUND

At present, Global Positioning System (GPS) can provide a comparatively accurate positioning service outdoors. However, there is no coverage of satellite signals or there is a poor coverage of the satellite signals indoors. It is infeasible to perform indoor positioning by means of GPS. Generally, a wireless communication system is used for positioning indoors. In a wireless mobile communication system, a user is in a coverage area of a cell base station. When the user communicates with the base station, the base station can tell the position of the user. In a wireless local network communication system, a terminal downloads, by associating with a wireless access point device, an indoor map and a list of wireless access points from a positioning server, so as to determine the position thereof.

However, positioning at the base station or a wireless transmission device to which the wireless access point device belongs requires the user or a wireless receiving device to which the terminal belongs to send a signal. If the wireless receiving device does not send the signal, positioning cannot be performed. When positioning is performed to a large number of wireless receiving devices in the wireless transmission device or the positioning server, real-time performance and high volume data processing capability of the wireless transmission device and the positioning server is required much. Positioning at the wireless receiving device requires a connection established between the wireless receiving device and the wireless transmission device, and the wireless receiving device needs to download from the positioning server the position information of the wireless transmission device and indoor map information, which requires the wireless receiving device and the positioning server to be highly coupled. For indoor positioning of the wireless communication system, a method for performing indoor positioning at the wireless receiving device side is needed. According to this method, the connection is not required to be established between the wireless receiving device and the wireless transmission device, and the wireless receiving device is not required to download information from the positioning server.

### SUMMARY

The embodiments of the disclosure provide an indoor positioning method, a wireless receiving device, a wireless transmission device and a storage medium, which solves such existing problems that when positioning is performed at a wireless receiving device side, a connection is not required to be established between a wireless transmission device and a wireless receiving device, and it is needed to acquire a map and position information of the wireless transmission device from a positioning server.

To solve the above technical problems, the embodiments of the disclosure provide an indoor positioning method. Position information transmitted by at least one opposite end is received through an air interface transmission interface. According to the position information of the at least one opposite end, position information of a local end is determined via a positioning algorithm.

In an embodiment of the disclosure, before the position information transmitted by the at least one opposite end is received through the air interface transmission interface, at least one opposite end with a higher signal receiving strength is selected according to the signal receiving strength. At least one piece of position request information is generated according to the at least one opposite end. The at least one piece of position request information is sent to the at least one opposite end.

In an embodiment of the disclosure, indoor environment information sent by the at least one opposite end is received through the air interface transmission interface.

In an embodiment of the disclosure, the position information of the local end is determined via the positioning algorithm according to the position information of the at least one opposite end includes that a distance between the local end and at least one opposite end is calculated according to the indoor environment information, and the position information of the local end is determined according to the position information of the at least one opposite end and the distance.

In an embodiment of the disclosure, after the position information of the local end is determined via the positioning algorithm according to the position information of the at least one opposite end, the position information of the local end is displayed on an indoor map pre-stored by the local end. And/or, the position information of the local end is sent to a third-party application.

The embodiments of the disclosure also provide an indoor positioning method. The position information of the local end is acquired. The position information is sent to the opposite end through the air interface transmission interface.

In an embodiment of the disclosure, longitude and latitude information of a position which the local end is at is acquired. Alternatively, longitude and latitude information of a reference position, and coordinate information of the position where the local end is relative to the reference position is acquired.

In an embodiment of the disclosure, indoor environment information is sent to the opposite end through the air interface transmission interface.

In an embodiment of the disclosure, the position request information sent by the opposite end is received. According to the position request information, the position information is sent to the opposite end through the air interface transmission interface.

An embodiment of the disclosure also provides an indoor positioning method. At least one wireless transmission device acquires the position information thereof, and sends the position information to the wireless receiving device through the air interface transmission interface. The wireless receiving device receives the position information sent by the at least one wireless transmission device through the air interface transmission interface, and determines the position information thereof via the positioning algorithm according to the position information of the at least one wireless transmission device.

An embodiment of the disclosure also provides a wireless receiving device, including a first receiving module configured to receive the position information transmitted by at last one opposite end through the air interface transmission interface and a calculating module configured to determine the position information of the local end via the positioning algorithm according to the position information of the at least one opposite end.

In an embodiment of the disclosure, the wireless receiving device further includes a selecting module configured to select at least one opposite end with a higher signal receiving strength according to the signal receiving strength, a generating module configured to generate at least one piece of position request information according to the at least one opposite end selected by the selecting module, and a first sending module configured to send the at least one piece of position request information generated by the generating module to the at least one opposite end.

In an embodiment of the disclosure, the first receiving module is further configured to receive, through the air interface transmission interface, the indoor environment information sent by the at least one opposite end.

In an embodiment of the disclosure, the calculating module is further configured to calculate a distance between the local end and at least one opposite end according to the indoor environment information received by the first receiving module. The calculating module is further configured to determine the position information of the local end according to the position information of the at least one opposite end and the distance.

In an embodiment of the disclosure, the wireless receiving device further includes a displaying module configured to display the position information of the local end, which is determined by the calculating module, on the indoor map pre-stored by the local end. The first sending module is further configured to send the position information of the local end, which is determined by the calculating module, to the third-party application.

An embodiment of the disclosure also provides a wireless transmission device, including an acquiring module configured to acquire the position information of the local end and a second sending module configured to send the position information to the opposite end via the air interface transmission interface.

In an embodiment of the disclosure, the acquiring module is further configured to acquire the longitude and latitude information of the position where the local end is. Alternatively, the acquiring module is further configured to acquire the longitude and latitude information of the reference position, and the coordinate information of the position where the local end is relative to the reference position.

In an embodiment of the disclosure, the second sending module is configured to send the indoor environment information to the opposite end through the air interface transmission interface.

In an embodiment of the disclosure, the wireless transmission device further includes a second receiving module configured to receive the position request information sent by the opposite end. The second transmitting module is further configured to send the position information to the opposite end through the air interface transmission interface according to the position request information received by the second receiving module.

The beneficial effects of the embodiments of the disclosure are as follows.

The embodiments of the disclosure provide an indoor positioning method, a wireless receiving device, a wireless transmission device and a storage medium. The wireless transmission device transmits the position information thereof to the wireless receiving device through the air interface transmission interface. The wireless receiving device receives the position information of the wireless transmission device through the air interface transmission interface, and determines the position information thereof via the positioning algorithm. There is no need to establish a connection between the wireless receiving device and the wireless transmission device. The wireless receiving device is required to neither download the position information of the wireless transmission device and map information from the positioning server nor acquire the map and the position information of the wireless transmission device from the positioning server. The method is particularly suitable for indoor positioning, and it is high in efficiency, strong in real-time performance and easy to be realized.

### BRIEF DESCRIPTION OF THE DRAWINGS

FIG. 1 is a flowchart showing an indoor positioning method provided by Embodiment One of the disclosure.

FIG. 2 is a flowchart showing an indoor positioning method provided by Embodiment Two of the disclosure.

FIG. 3 is a schematic diagram illustrating an indoor positioning coordinate system provided by Embodiment Two of the disclosure.

FIG. 4 is a schematic diagram illustrating an interface format provided by Embodiment Two of the disclosure.

FIG. 5 is a flowchart showing an indoor positioning method provided by Embodiment Three of the disclosure.

FIG. 6 is a structure diagram illustrating a wireless receiving device provided by Embodiment Four of the disclosure.

FIG. 7 is a structure diagram illustrating a wireless transmission device provided by Embodiment Five of the disclosure.

### DETAILED DESCRIPTION

The technical solutions in the embodiments of the disclosure are clearly and completely elaborated below in combination with the accompanying drawings. Obviously, the described embodiments are only a part of the embodiments of the disclosure but not all. Based on the embodiments of the disclosure, all the other embodiments obtained by those skilled in the art without creative efforts fall within the scope of protection of the disclosure.

The disclosure is further elaborated below by means of specific embodiments in combination with the accompanying drawings.

### Embodiment One

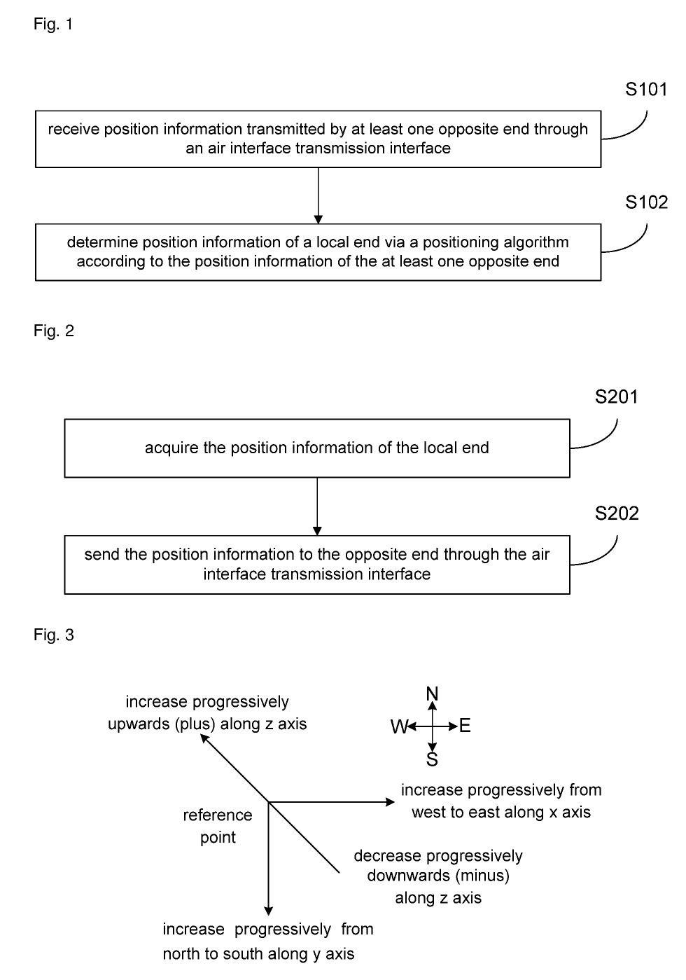

FIG. 1 is a flowchart showing an indoor positioning method provided by Embodiment One of the disclosure. As shown in FIG. 1, at a wireless receiving device side, the indoor positioning method includes the following steps.

At S101, position information transmitted by at last one opposite end is received through an air interface transmission interface.

At S102, according to the position information of the at least one opposite end, position information of a local end is determined via a positioning algorithm.

Specifically, in a wireless mobile communication system or a wireless local network communication system, in order to perform indoor positioning for a wireless receiving device, for example, in order to perform indoor positioning for a terminal, the wireless receiving device receives the position information transmitted by at least one opposite end through the air interface transmission interface. According to the position information transmitted by the at least one opposite end, the wireless receiving device determines the position information thereof by calling the positioning algorithm. The wireless receiving device includes, but is not limited to, the terminal. The opposite end may be a wireless transmission device, such as a base station or a wireless access point device. Because the wireless receiving device receives the position information transmitted by the wireless transmission device through the air interface transmission interface, there is no need to establish a communication connection between the wireless transmission device and the wireless receiving device, and there is no need to acquire the position information of the wireless transmission device from the positioning server. The method is high in efficiency, strong in real-time performance and easy to be realized.

In the embodiment of the disclosure, the wireless receiving device receives the position information of the wireless transmission device through the air interface transmission interface by, but not limited to, the following ways.

(1) When the wireless transmission device actively broadcasts the position information thereof through the air interface transmission interface, the wireless receiving device receives the position information transmitted by the wireless transmission device through the air interface transmission interface.

(2) The wireless receiving device scans the wireless transmission devices in the indoor environment, and selects at least one wireless transmission device with a stronger signal receiving strength according to the signal receiving strength, so as to make the positioning result more accurate. The wireless receiving device generates at least one piece of position request information according to the at least one wireless transmission device, and sends the at least one piece of position request information to the at least one wireless transmission device through the air interface transmission interface. The at least one wireless transmission device sends the position information thereof to the wireless receiving device through the air interface transmission interface according to the position request information. Then, the wireless receiving device can receive the position information transmitted by the wireless transmission device through the air interface transmission interface.

In the present embodiment, the wireless transmission device can also send indoor environment information to the wireless receiving device through the air interface transmission interface. The wireless receiving device receives the indoor environment information transmitted by at least one wireless transmission device through the air interface transmission interface. The indoor environment information is mainly used for calculating a distance between the wireless transmission device and the wireless receiving device, and it may include at least one of the following information.

(1) A logarithmetics “distance-loss” model based on a received signal strength and the parameters thereof:

$$P = {P}_{0} + 10 nlg ( \frac{d}{{d}_{0}} ) + ζ .$$

The wireless transmission device may preset a reference distance d₀. According to the reference distance d₀, a received signal power P₀ at the reference distance d₀ is obtained. A path loss factor n and a shadowing factor ζ are obtained by looking up tables. Then, the logarithmetics “distance-loss” model based on a received signal strength

$$P = {P}_{0} + 10 nlg ( \frac{d}{{d}_{0}} ) + ζ$$

is determined according to the reference distance d₀, the received signal power P₀, the path loss factor n and the shadowing factor ζ. Herein, d may represent the distance between the wireless transmission device and the wireless receiving device, and P is the received signal strength at the distance d.

(2) A “distance-time” model based on time of arrival and the parameters thereof: d=(t₂−t₁)c.

When the wireless transmission device sends the “distance-time” model and the parameters thereof, the transmitting time t₁ may be obtained. According to the transmitting time t₁ and the velocity of light c, the “distance-time” model based on the time of arrival d=(t₂−t₁)c is determined. Herein, d may represent the distance between the wireless transmission device and the wireless receiving device, and t₂ is the time when the wireless receiving device receives the “distance-time” model and the parameters thereof.

In the above technical solutions, the wireless receiving device calculates, according to the indoor environment information transmitted by the wireless transmission device, the distance between itself and at least one wireless transmission device. The calculating ways include, but are not limited to, the following ways.

(1) If the indoor environment information is the parameters of the logarithmetics “distance-loss” model based on the received signal strength

$$P = {P}_{0} + 10 nlg ( \frac{d}{{d}_{0}} ) + ζ ,$$

the wireless receiving device receives the parameters of the “distance-loss” model transmitted by the at least one wireless transmission device, and calculates the distance d between the wireless receiving device and the at least one wireless transmission device according to the “distance-loss” model

$$P = {P}_{0} + 10 nlg ( \frac{d}{{d}_{0}} ) + ζ ,$$

the reference distance d₀, the received signal strength P₀ at the reference distance d₀, the path loss factor n and the shadowing factor ζ in combination with the received signal strength P of the at least one wireless transmission device.

(2) If the indoor environment information is the parameters of the “distance-time” model based on time of arrival d=(t₂−t₁)c, the wireless receiving device receives the parameters of the “distance-time” model transmitted by the at least one wireless transmission device, and calculates the distance d between the wireless receiving device and the at least one wireless transmission device according to the “distance-time” model d=(t₂−t₁)c, the sending time t₁ and the velocity of light c in combination with receiving time t₂ of the at least one wireless transmission device.

(3) If the indoor environment information includes both the parameters of the logarithmetics “distance-loss” model based on the received signal strength

$$P = {P}_{0} + 10 nlg ( \frac{d}{{d}_{0}} ) + ζ$$

and the parameters of the “distance-time” model based on time of arrival d=(t₂−t₁)c, the wireless receiving device can calculate the distance d between the wireless receiving device and the at least one wireless transmission device in combination with the two models. For example, the wireless receiving device calculates the distances d by respectively adopting the two models and then takes an average, thereby improving the accuracy of calculation, and making positioning more accurate.

In the above technical solutions, after calculating the distance between the wireless receiving device and at least one wireless transmission device, the wireless receiving device can determine the position information of the wireless receiving device with reference to the position information of the wireless transmission device. Note that, when the number of the wireless transmission devices is less than 3, it is also feasible to position the wireless receiving device. However, the positioning accuracy is not high, and there is no directionality. In the present embodiment, in order to be able to position the wireless receiving device accurately, the way of determining the position information of the wireless receiving device is illustrated by taking at least three wireless transmission devices as an example. The position of any one of the at least three wireless transmission devices is taken as the origin of coordinates. That is, a wireless transmission device is randomly selected from the at least three wireless transmission devices, and the position of the selected wireless transmission device is defined as the origin of coordinates. Then, according to the position information of the at least three wireless transmission devices, coordinates (xᵢ,yᵢ) i=1, 2, 3, . . . , relative to the origin of coordinates, of other wireless transmission devices in the at least three wireless transmission devices are calculates respectively. According to d²=(x−xᵢ)²+(y−yᵢ)² in combination with the distances d between the wireless receiving device and the at least three wireless transmission devices respectively, the coordinates (x,y) of the wireless receiving device relative to the selected wireless transmission device, namely the coordinates relative to the origin of coordinates, are calculated. After the coordinates (x,y) of the wireless receiving device are calculated, the position information, for example, the longitude and latitude information, of the wireless receiving device is determined according to the position information, for example, the longitude and latitude information, of the wireless transmission device at the origin of coordinates, so as to perform indoor positioning for the wireless receiving device.

In the present embodiment, after the position information of the local end is determined via the positioning algorithm according to the position information of the at least one opposite end, the wireless receiving device may use the position information thereof. For example, but not limited to, the wireless receiving device can display the position information thereof on the pre-stored indoor map for the user to check. And/or, the wireless receiving device sends the position information thereof to a third-party application, so that the third-party application acquires the position information of the wireless receiving device, and then performs corresponding operations.

The embodiments of the disclosure also provide a first computer readable storage medium having a set of instructions and the instructions are used for performing the indoor positioning method in Embodiment One.

### Embodiment Two

FIG. 2 is a flowchart showing an indoor positioning method provided by Embodiment Two of the disclosure. As shown in FIG. 2, at a wireless transmission device side, the indoor positioning method includes the following steps.

At S201, the position information of the local end is acquired.

At S202, the position information is sent to the opposite end through the air interface transmission interface.

Specifically, in the wireless mobile communication system or the wireless local network communication system, in order to perform indoor positioning for the wireless receiving device, for example, in order to perform indoor positioning for the terminal, the wireless transmission device acquires its own position information, and sends its own position information to the wireless receiving device through the air interface transmission interface, so that the wireless receiving device can complete indoor positioning by itself according to the position information of the wireless transmission device. The wireless transmission device includes, but is not limited to, the base station and the wireless access point device. The opposite end may be the wireless receiving device, for example, the terminal. Because the wireless transmission device sends its own position information through the air interface transmission interface, there is no need to establish the communication connection between the wireless transmission device and the wireless receiving device. Accordingly, the method is high in efficiency, strong in real-time performance and easy to be realized.

In the embodiment of the disclosure, the position information of the wireless transmission device includes, but is not limited to, the following information.

(1) If the wireless transmission device may acquire the longitude and latitude information of its position indoors, the longitude and latitude information is directly taken as the position information of the wireless transmission device, so that the longitude and latitude information of the position of the wireless transmission device is acquired.

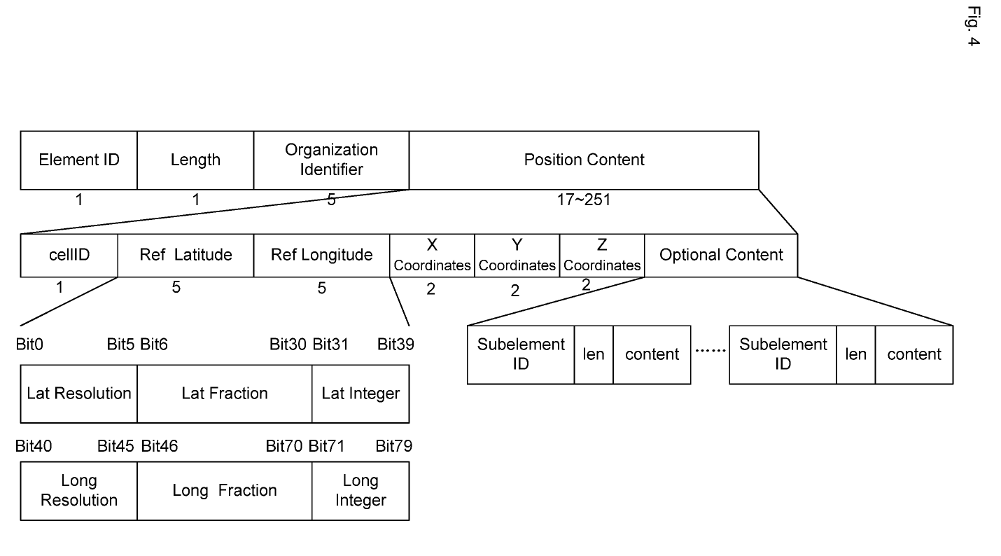

(2) If the wireless transmission device cannot acquire the longitude and latitude information of its position indoors, a certain reference position indoors may be selected. The longitude and latitude information of the reference position and offset information of the position where the wireless transmission device is relative to the reference position are taken as the position information of the wireless transmission device. As such, the longitude and latitude information of the reference position and the offset information of the position where the wireless transmission device is relative to the reference position are acquired. The granularity of the offset information may be set according to the positioning accuracy. For example, when the positioning accuracy is 1 m, the granularity of relative offset may be set as 0.1 m. The reference position may be selected in advance. For example, a larger indoor space can be divided into multiple areas, and a reference position may be set in each of the areas. FIG. 3 is a schematic diagram illustrating an indoor positioning coordinate system provided by Embodiment Two of the disclosure. As shown in FIG. 3, a ground position at the northwest corner indoors is taken as the reference point position, so x=0, y=0, and z=0. Furthermore, it is defined that the x axis increases progressively from west to east, the y axis increases progressively from north to south, and the z axis increases progressively above the ground and decreases progressively below the ground. Thus, the position information of the wireless transmission device can be determined.

In the present embodiment, after the wireless transmission device acquires the position information of the local end, a triggering way of sending the position information through the air interface transmission interface includes, but is not limited to, the following ways.

(1) After acquiring the position information of the local end, the wireless transmission device can actively broadcast the acquired position information of the local end through the air interface transmission interface, so that the wireless receiving device receives the position information transmitted by the wireless transmission device through the air interface transmission interface.

(2) After acquiring the position information of the local end, the wireless transmission device has no need to broadcast the acquired position information of the local end through the air interface transmission interface. When receiving the position request information sent by the wireless receiving device, the wireless transmission device sends the acquired position information of the local end to the wireless receiving device through the air interface transmission interface according to the position request information.

In the present embodiment, the wireless transmission device may also send the indoor environment information to the wireless receiving device through the air interface transmission interface. The indoor environment information is mainly used for calculating the distance between the wireless transmission device and the wireless receiving device, and it may include at least one of the following information.

(1) The logarithmetics “distance-loss” model based on the received signal strength and its parameters:

$$P = {P}_{0} + 10 nlg ( \frac{d}{{d}_{0}} ) + ζ .$$

The wireless transmission device may preset the reference distance d₀. According to the reference distance d₀, the received signal power P₀ at the reference distance d₀ is obtained. The path loss factor n and the shadowing factor ζ are obtained by looking up tables. Then, the logarithmetics “distance-loss” model based on the received signal strength

$$P = {P}_{0} + 10 nlg ( \frac{d}{{d}_{0}} ) + ζ$$

is determined according to the reference distance d₀, the received signal power P₀, the path loss factor n and the shadowing factor ζ. Herein, d can represent the distance between the wireless transmission device and the wireless receiving device, and P is the received signal strength at the distance d.

(2) The “distance-time” model based on time of arrival and its parameters: d=(t₂−t₁)c.

When the wireless transmission device sends the “distance-time” model and its parameters, its transmitting time t₁ may be obtained. According to the transmitting time t₁ and the velocity of light c, the “distance-time” model based on the time of arrival d=(t₂−t₁)c is determined. Herein, d may represent the distance between the wireless transmission device and the wireless receiving device, and t₂ is the time when the wireless receiving device receives the “distance-time” model and its parameters.

In the above solution, the wireless transmission device may fill the position information and the indoor environment information according to a specific interface format. After filling, the wireless transmission device sends the information through a management frame in the wireless communication system, such as, the beacon frame or the probe response frame. FIG. 4 is a schematic diagram illustrating an interface format provided by Embodiment Two of the disclosure. As shown in FIG. 4, the position information of the wireless transmission device is given in form of little endian with reference to the defined format structure Gbit resolution, 25 bit fraction, 9 bit integer in Request For Comments (RFC) 3825 (July 2004) of Internet Engineering Task Force (IETF). X and Y coordinates are defined according to a 2-byte unsigned number, falling within the maximum range of 0 m to 6553.6 m, and Z coordinates are defined according to a 2-byte signed number, falling within the maximum range of −3276.8 to +3276.7. The indoor environment information needed in the positioning algorithm is self-defined in Optional Content.

The embodiments of the disclosure also provide a second computer readable storage medium having a set of instructions and the instructions are used for performing the indoor positioning method in Embodiment Two.

### Embodiment 3

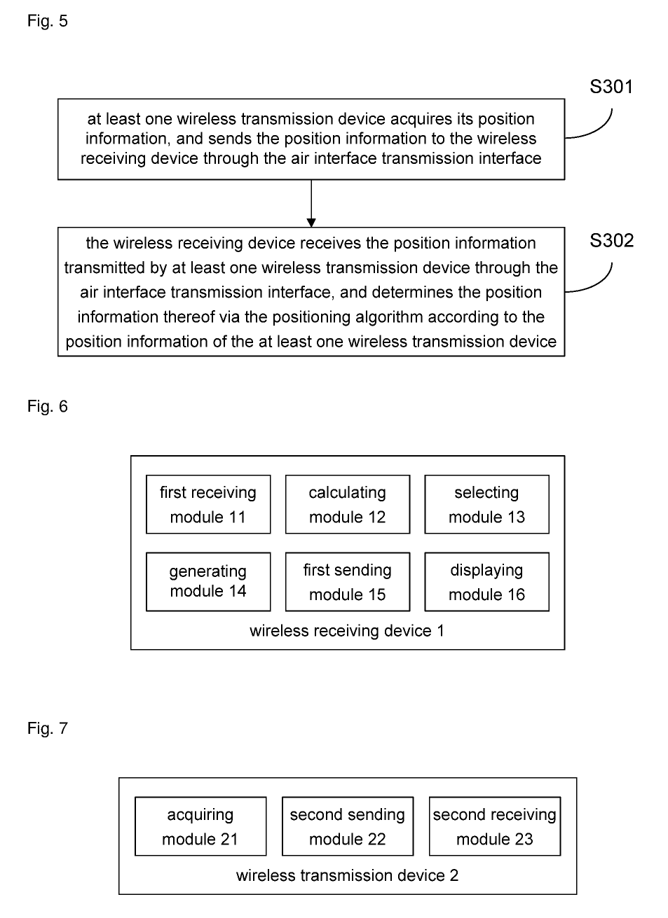

FIG. 5 is a flowchart showing an indoor positioning method provided by Embodiment Three of the disclosure. As shown in FIG. 5, the indoor positioning method includes the following steps.

At S301, at least one wireless transmission device acquires its position information, and sends the position information to the wireless receiving device through the air interface transmission interface.

At S302, the wireless receiving device receives the position information transmitted by at least one wireless transmission device through the air interface transmission interface. According to the position information of the at least one wireless transmission device, the position information of the wireless receiving device is determined via the positioning algorithm.

Specifically, in order to perform accurate indoor positioning to the wireless receiving device, at least one wireless transmission device acquires its own position information. After acquiring its own position information, the wireless transmission device may actively broadcast its own position information through the air interface transmission interface. Alternatively, according to the position request information from the wireless receiving device, the wireless transmission device sends its own position information to the wireless receiving device through the air interface transmission interface. Thus, the wireless receiving device receives the position information transmitted by the wireless transmission device through the air interface transmission interface. After receiving the position information of the wireless transmission device, the wireless receiving device completes its own indoor positioning via the positioning algorithm.

The embodiments of the disclosure also provide a third computer readable storage medium having a set of instructions and the instructions are used for performing the indoor positioning method in Embodiment Three.

### Embodiment Four

FIG. 6 is a structure diagram illustrating a wireless receiving device provided by Embodiment Four of the disclosure. As shown in FIG. 6, the wireless receiving device 1 includes a first receiving module 11 and a calculating module 12.

The first receiving module 11 is configured to receive the position information transmitted by at last one opposite end through the air interface transmission interface.

The calculating module 12 is configured to, according to the position information of the at least one opposite end received by the first receiving module 11, determine the position information of the local end via the positioning algorithm.

Preferably, the wireless receiving device 1 further includes a selecting module 13, a generating module 14 and a first sending module 15. The selecting module 13 is configured to select at least one opposite end with the higher signal receiving strength according to the signal receiving strength. The generating module 14 is configured to generate at least one piece of position request information according to the at least one opposite end selected by the selecting module 13. The first sending module 15 is configured to send the at least one piece of position request information generated by the generating module 14 to the at least one opposite end.

Preferably, the first receiving module 11 is further configured to receive, through the air interface transmission interface, the indoor environment information sent by the at least one opposite end.

Preferably, the calculating module 12 is further configured to calculate the distance between the local end and at least one opposite end according to the indoor environment information received by the first receiving module 11. The calculating module 11 is further configured to determine the position information of the local end according to the position information of the at least one opposite end and the distance.

Preferably, the wireless receiving device 1 further includes a displaying module 16. The displaying module 16 is configured to display the position information of the local end, which is determined by the calculating module 12, on the indoor map pre-stored by the local end. The first sending module 15 is further configured to send the position information of the local end, which is determined by the calculating module 12, to the third-party application.

In practice, all of the calculating module 12, the selecting module 13 and the generating module 14 may be realized by a Central Processing Unit (CPU), a Digital Signal Processor (DSP), or a Field Programmable Gate Array (FPGA). The first receiving module 11 and the first sending module 15 may be realized by a receiver and a transmitter in the wireless receiving device provided by Embodiment Four. The displaying module 16 may be realized by a display in the wireless receiving device provided by Embodiment Four. All of the CPU, the DSP and the FPGA may be built in the wireless receiving device provided by Embodiment Four.

### Embodiment Five

FIG. 7 is a structure diagram illustrating a wireless transmission device provided by Embodiment Five of the disclosure. As shown in FIG. 7, the wireless transmission device 2 includes an acquiring module 21 and a second sending module 22.

The acquiring module 21 is configured to acquire the position information of the local end.

The second sending module 22 is configured to send the position information acquired by the acquiring module 21 to the opposite end through the air interface transmission interface.

Preferably, the acquiring module 21 is further configured to acquire the longitude and latitude information of the position where the local end is. Alternatively, the acquiring module 21 is further configured to acquire the longitude and latitude information of the reference position, and the coordinate information of the position of the local end relative to the reference position.

Preferably, the second sending module 22 is configured to send the indoor environment information to the opposite end through the air interface transmission interface.

Preferably, a second receiving module 23 is further included. The second receiving module 23 is configured to receive the position request information sent by the opposite end. The second transmitting module 22 is further configured to, according to the position request information received by the second receiving module 23, send the position information to the opposite end through the air interface transmission interface.

In practice, the acquiring module 21 may be realized by the CPU, or the DSP, or the FPGA. The second sending module 22 and the second receiving module 23 may be realized by the receiver and the transmitter in the wireless receiving device provided by Embodiment Five. All of the CPU, the DSP and the FPGA may be built in the wireless receiving device provided by Embodiment Five.

Those skilled in the art should understand that the embodiments of the disclosure may be provided as a method, a system or a computer program product. Thus, hardware, software or a combination thereof may be adopted in the disclosure. Moreover, a form of the computer program product implemented on one or more computer available storage media (including, but not limited to, a disk memory, an optical memory and the like) containing computer available program codes can be adopted in the disclosure.

The disclosure is described with reference to flowcharts and/or block diagrams of the method, the equipment (system) and the computer program product according to the embodiments of the disclosure. It should be understood that each flow and/or block in the flowcharts and/or the block diagrams and a combination of the flows and/or the blocks in the flowcharts and/or the block diagrams can be realized by computer program instructions. These computer program instructions can be provided for a general computer, a dedicated computer, an embedded processor or processors of other programmable data processing devices to generate a machine, so that an apparatus for realizing functions assigned in one or more flows of the flowcharts and/or one or more blocks of the block diagrams is generated via instructions executed by the computers or the processors of the other programmable data processing devices.

These computer program instructions can also be stored in a computer readable memory capable of guiding the computers or the other programmable data processing devices to work in a specific mode, so that a manufactured product including an instruction apparatus is generated via the instructions stored in the computer readable memory, and the instruction apparatus realizes the functions assigned in one or more flows of the flowcharts and/or one or more blocks of the block diagrams.

These computer program instructions can also be loaded to the computers or the other programmable data processing devices, so that processing realized by the computers is generated by executing a series of operation steps on the computers or the other programmable devices, and therefore the instructions executed on the computers or the other programmable devices provide steps of realizing the functions assigned in one or more flows of the flowcharts and/or one or more blocks of the block diagrams.

The above is only the embodiments of the disclosure. It should be indicated that, on the premise of not departing from the principles of the disclosure, those ordinary skilled in the art may also make improvements and modifications, and these improvements and modifications should fall within the scope of the disclosure.

### INDUSTRIAL APPLICABILITY

In the embodiments of the disclosure, the wireless transmission device transmits its own position information to the wireless receiving device through the air interface transmission interface. The wireless receiving device receives the position information of the wireless transmission device through the air interface transmission interface, and determines the position information thereof via the positioning algorithm. There is no need to establish a connection between the wireless receiving device and the wireless transmission device. The wireless receiving device is not required to download the position information of the wireless transmission device and map information from the positioning server and acquire the map and the position information of the wireless transmission device from the positioning server. The disclosure is particularly suitable for indoor positioning, and it is high in efficiency, strong in real-time performance and easy to be realized.

1. An indoor positioning method, comprising:
receiving position information transmitted by at least one opposite end through an air interface transmission interface; and
determining position information of a local end via a positioning algorithm according to the position information of the at least one opposite end.

2. The indoor positioning method according to claim 1, before receiving the position information transmitted by at least one opposite end through the air interface transmission interface, further comprising:
selecting at least one opposite end with a higher signal receiving strength according to the signal receiving strength;
generating at least one piece of position request information according to the at least one opposite end; and
sending the at least one piece of position request information to the at least one opposite end.

3. The indoor positioning method according to claim 1, further comprising:
receiving, through the air interface transmission interface, indoor environment information sent by the at least one opposite end.

4. The indoor positioning method according to claim 3, wherein determining the position information of the local end via the positioning algorithm according to the position information of the at least one opposite end comprises:
calculating a distance between the local end and at least one opposite end according to the indoor environment information; and
determining the position information of the local end according to the position information of the at least one opposite end and the distance.

5. The indoor positioning method according to claim 1, after determining the position information of the local end via the positioning algorithm according to the position information of the at least one opposite end, further comprising:
displaying the position information of the local end on an indoor map pre-stored by the local end; and/or,
sending the position information of the local end to a third-party application.

6. The indoor positioning method according to claim 1, before receiving the position information transmitted by at least one opposite end through the air interface transmission interface, the method further comprising:
acquiring the position information by the at least one opposite end; and
sending, by the at least one opposite end, the position information to the local end through the air interface transmission interface.

7. The indoor positioning method according to claim 6, wherein acquiring the position information by the at least one opposite end comprises:
acquiring longitude and latitude information of a position of the at least one opposite end; or,
acquiring longitude and latitude information of a reference position, and coordinate information of the position of the at least one opposite end relative to the reference position.

8. The indoor positioning method according to claim 6, further comprising:
sending indoor environment information to the local end through the air interface transmission interface.

9. The indoor positioning method according to claim 6, wherein sending the position information to the local end through the air interface transmission interface comprises:
receiving position request information sent by the local end; and
sending the position information to the local end through the air interface transmission interface according to the position request information.

10. The indoor positioning method according to claim 1, wherein the at least one opposite end is at least one wireless transmission device and the local end is a wireless receiving device.

11. A wireless receiving device, comprising:
a first receiving module, configured to receive position information transmitted by at least one opposite end through an air interface transmission interface; and
a calculating module, configured to determine position information of a local end via a positioning algorithm according to the position information of the at least one opposite end.

12. The wireless receiving device according to claim 11, further comprising:
a selecting module, configured to select at least one opposite end with a higher signal receiving strength according to the signal receiving strength;
a generating module, configured to generate at least one piece of position request information according to the at least one opposite end selected by the selecting module; and
a first sending module, configured to send the at least one piece of position request information generated by the generating module to the at least one opposite end.

13. The wireless receiving device according to claim 11, wherein
the first receiving module is further configured to receive, through the air interface transmission interface, indoor environment information sent by the at least one opposite end.

14. The wireless receiving device according to claim 13, wherein
the calculating module is further configured to calculate a distance between the local end and at least one opposite end according to the indoor environment information received by the first receiving module; and
the calculating module is further configured to determine the position information of the local end according to the position information of the at least one opposite end and the distance.

15. The wireless receiving device according to claim 12, further comprising:
a displaying module, configured to display the position information of the local end, which is determined by the calculating module, on an indoor map pre-stored by the local end;
wherein the first sending module is further configured to send the position information of the local end, which is determined by the calculating module, to a third-party application.

16. A wireless transmission device, comprising:
an acquiring module, configured to acquire position information of a local end; and
a second sending module, configured to send the position information to an opposite end through an air interface transmission interface.

17. The wireless transmission device according to claim 16, wherein
the acquiring module is further configured to acquire longitude and latitude information of a position of the local end; or, the acquiring module is further configured to acquire longitude and latitude information of a reference position, and coordinate information of the position of the local end relative to the reference position.

18. The wireless transmission device according to claim 16, wherein
the second sending module is configured to send indoor environment information to the opposite end through the air interface transmission interface.

19. The wireless transmission device according to claim 16, further comprising:
a second receiving module, configured to receive position request information sent by the opposite end,
wherein the second sending module is further configured to send the position information to the opposite end through the air interface transmission interface according to the position request information received by the second receiving module.

20. A non-transitory computer readable storage medium having a set of instructions stored therein, wherein the instructions, when executed by a computer, cause the computer to perform the indoor positioning method according to claim 1.

21.-22. (canceled)
